(19) United States
(12) Patent Application Publication
(10) Pub. No.: US 2020/0231264 A1
(43) Pub. Date: Jul. 23, 2020

(54) ELECTRICALLY OPERATED WATER DEVICE

(71) Applicant: Homare Imai, Taichung City (TW)

(72) Inventor: Homare Imai, Taichung City (TW)

(21) Appl. No.: 16/252,523

(22) Filed: Jan. 18, 2019

(51) Int. Cl. B63H 20/02; H02K 5/18; B63H 20/00

(52) U.S. Cl. CPC B63H 20/02; B63H 20/007; H02K 5/18

(57) ABSTRACT

An electrically operated water device includes: a sports carrier; a propeller connected to the sports carrier to generate mechanical power for driving the sports carrier to move in a direction; a battery unit arranged in the sports carrier for releasing electrical power stored therein; an electronic speed control arranged in the sports carrier and electrically connected to the battery unit and the propeller to supply electrical power from the battery unit to the propeller and to control an amount of the mechanical power generated by the propeller; and a first heat dissipation device coupled to the electronic speed control and having a plurality of first fins arranged parallel to each other to have every two adjacent ones of the first fins define therebetween a first heat dissipation trough in communication with a bottom the sports carrier and extending in a direction corresponding to the moving direction of the sports carrier.

### (a) TECHNICAL FIELD OF THE INVENTION

The present invention relates generally to an electrically operated water device, and more particularly to an electrically operated water device with enhanced heat dissipation performance.

### (b) DESCRIPTION OF THE PRIOR ART

The increasing progress of technology and science bring electrification of various water sports devices, such as electrified surfboards, electrified buoys, electrified hydrofoils, and electrified diving accessories, leading to diversification of water sports and also helping people to save physical strength.

Electrification of water sports devices is generally achieved with a battery that supplies electrical power under the control of an electronic speed control (ESC) to a driving device, such as a propeller, to generate mechanical power with the propeller to drive the water sports device to move forward.

However, both the ESC and the battery generate heat. Poor heat dissipation would lead to deterioration of performance and may cause undesired breakdown or failure.

### SUMMARY OF THE INVENTION

In view of the above, the present invention is made to improve the prior art for the issue of poor heat dissipation of the electrically operation water devices, which leads to deterioration of operation performance and causes easy damage and breakdown.

An objective of the present invention is to provide an electrically operated water device in which a first heat dissipation device is provided on an electronic speed control to enhance heat dissipation performance for the electronic speed control in order to prevent undesired deterioration of operation performance and also to extend service life of the electronic speed control.

Another objective of the present invention is to provide an electrically operated water device in which a second heat dissipation device is provided on a battery to enhance heat dissipation performance for the battery so as to prevent undesired deterioration of operation performance and also to extend service life of the battery.

Thus, the present invention provides an electrically operated water device, which generally comprises: a sports carrier; a propeller, which is connected to the sports carrier to generate mechanical power for driving the sports carrier to move in a direction; a battery unit, which is arranged on the sports carrier for storing and releasing electrical power; an electronic speed control, which is arranged on the sports carrier and is electrically connected to the battery unit and the propeller to supply electrical power from the battery unit to the propeller and to control an amount of the mechanical power generated by the propeller; a first heat dissipation device, which is coupled to the electronic speed control and comprises a plurality of first fins, wherein the first fins are arranged in a manner of being parallel to and spaced from each other at a fixed interval so that every two adjacent ones of the first fins define therebetween a first heat dissipation trough, the first heat dissipation troughs being in communication with a bottom of the sports carrier, each of the first heat dissipation troughs extending in a direction that corresponds to the moving direction of the sports carrier. With such a structural arrangement, effects of enhanced heat dissipation and extension of service life can be achieved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of first preferred embodiment the present invention.

FIG. 2 is an exploded view showing a portion of the embodiment of FIG. 1 with a part thereof being shown in an enlarged view.

FIG. 3 is an exploded view showing a portion of the embodiment of FIG. 1 with a part thereof being shown in an enlarged view.

FIG. 4 is a perspective view showing the embodiment of FIG. 1 in an assembled form.

FIG. 5 is a cross-sectional view of the embodiment of FIG. 1 in an assembled form.

FIG. 6 is a perspective view showing a second preferred embodiment of the present invention in an assembled form.

FIG. 7 is a schematic view showing an example of use of the embodiment of FIG. 6.

FIG. 8 is a schematic view showing an example of use of the embodiment of FIG. 6.

FIG. 9 is a perspective view, partly in a see-through form, showing a third preferred embodiment of the present invention.

FIG. 10 is a perspective view, partly in a see-through form, showing a fourth preferred embodiment of the present invention.

FIG. 11 is a perspective view showing a fifth preferred embodiment of the present invention.

FIG. 12 is a side-elevational view, partly in a see-through form, showing a sixth preferred embodiment of the present invention.

FIG. 13 is a side-elevational view, partly in a see-through form, showing a seventh preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

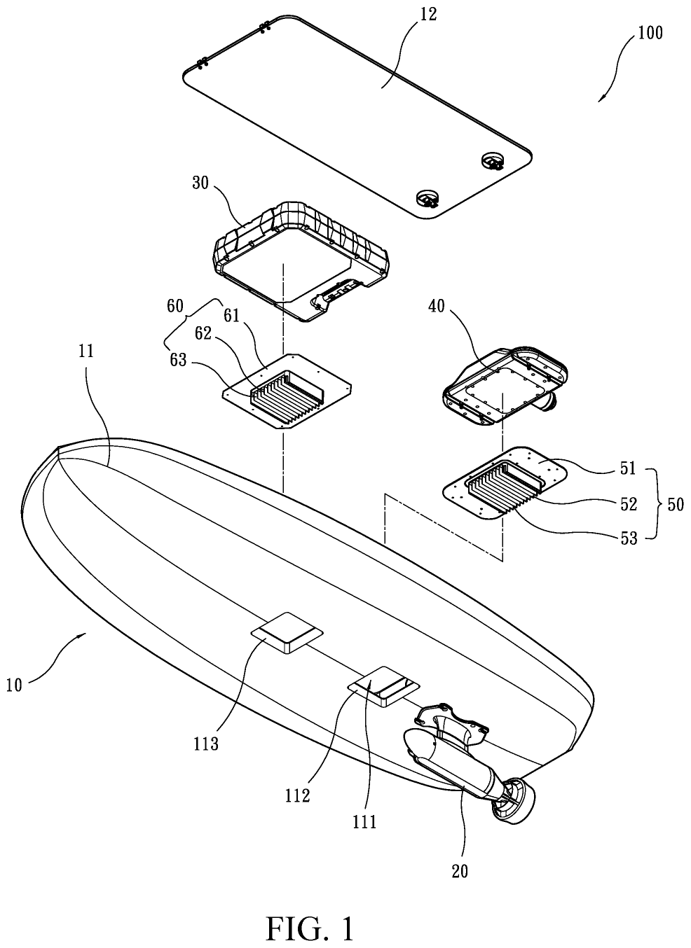

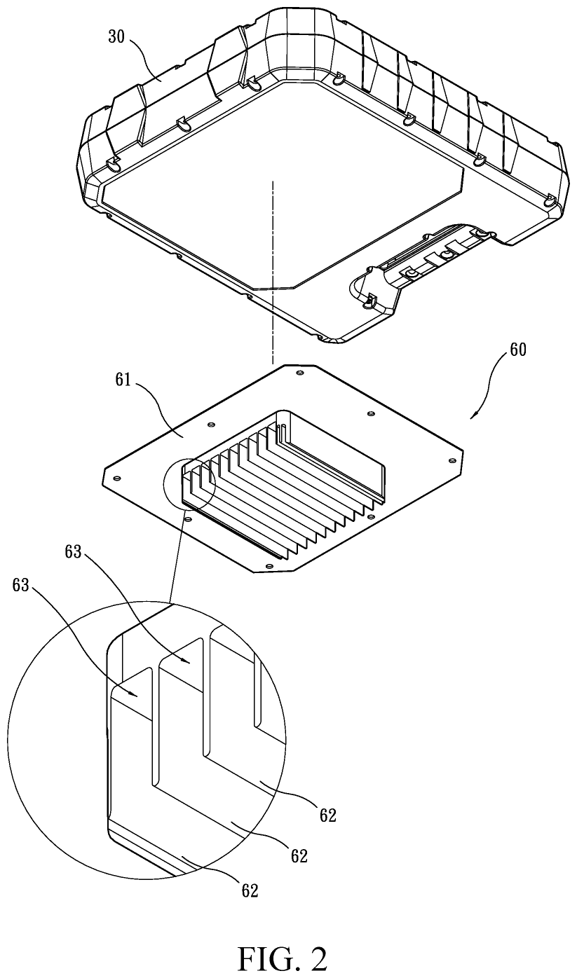

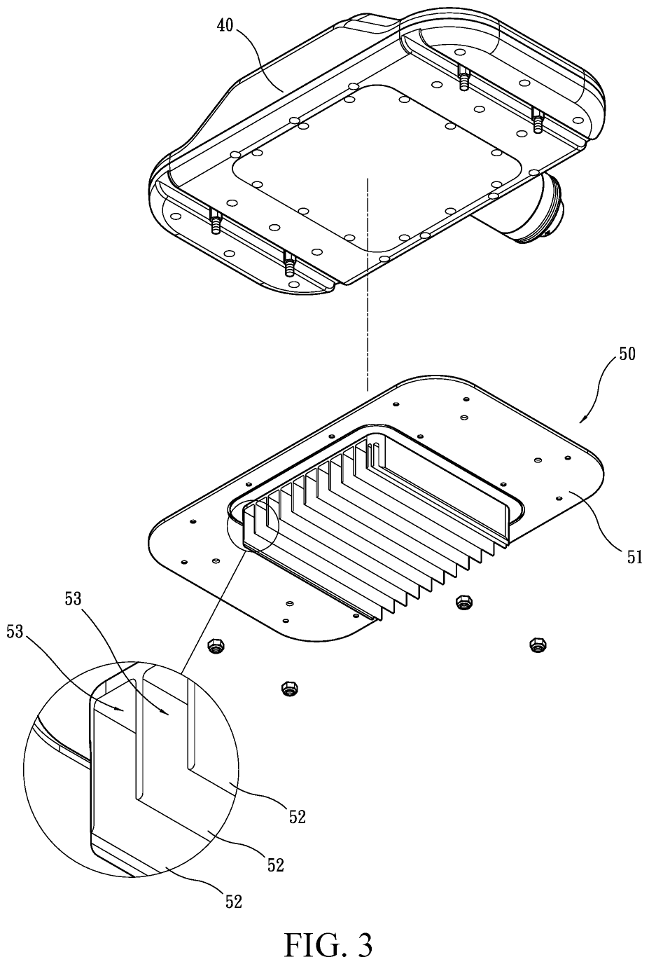

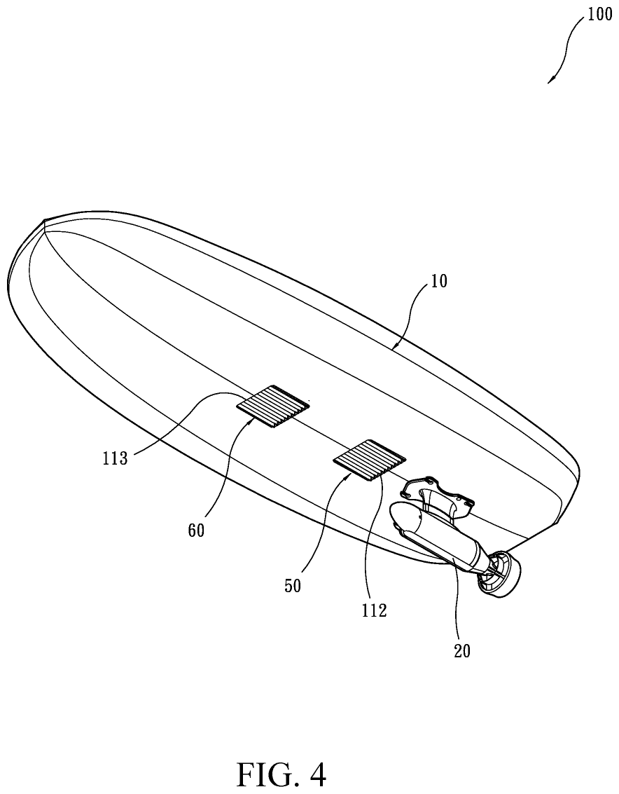

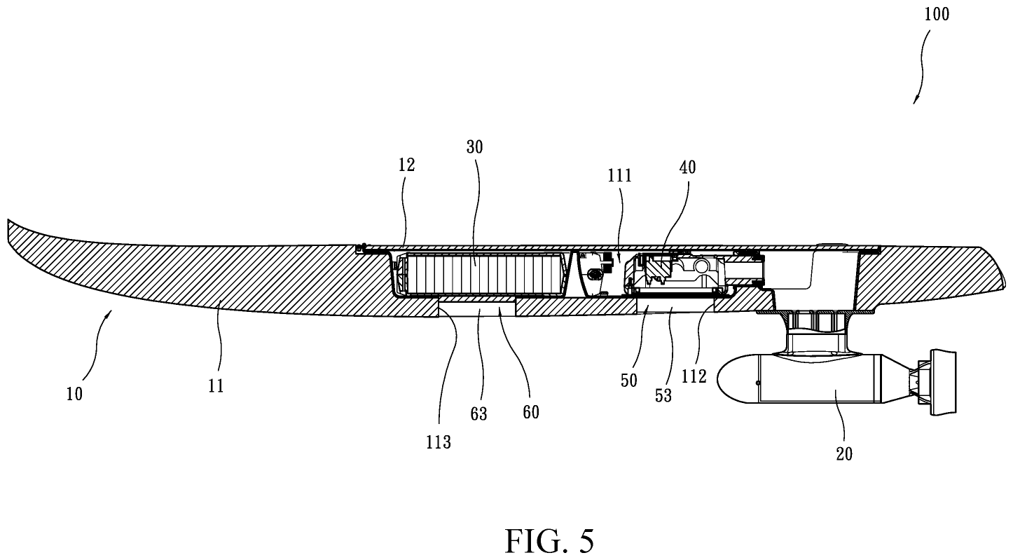

Referring to FIGS. 1-5, a first preferred embodiment of the present invention provides an electrically operated water device 100, which generally comprises a sports carrier 10, a propeller 20, a battery unit 30, an electronic speed control 40, a first heat dissipation device 50, and a second heat dissipation device 60.

Referring to FIGS. 1-5, the sports carrier 10 is a surfboard in the instant embodiment. The sports carrier 10 comprises a main body 11 and a cover plate 12. The main body 11 has a top surface that is recessed downward to form an accommodation zone 111. The main body 11 has a bottom surface that is recessed upward to form a first heat dissipation zone 112. The first heat dissipation zone 112 connects the outside to the accommodation zone 111. The bottom surface of the main body is recessed upward to form a second heat dissipation zone 113. The second heat dissipation zone 113 connects the outside to the accommodation zone 111. The first heat dissipation zone 112 and the second heat dissipation zone 113 are spaced from each other by a distance. The cover plate 12 is set on and cover the top surface of the main body 11 to close the accommodation zone 111.

Referring to FIGS. 1-5, the propeller 20 is connected to the sports carrier 10 to generate mechanical power for driving the sports carrier 10 to move in a direction.

Referring to FIGS. 1-5, the battery unit 30 is arranged in the accommodation zone 111 of the sports carrier 10 for storing and releasing electrical power.

Referring to FIGS. 1-5, the electronic speed control 40 is disposed in the accommodation zone 111 of the sports carrier 10 and is electrically connected to the battery unit 30 and the propeller 20 to supply electrical power from the battery unit 30 to the propeller 20 and to control an amount of the mechanical power generated by the propeller 20.

Referring to FIGS. 1-5, the first heat dissipation device 50 comprises a first base plate 51 and a plurality of first fins 52. The first fins 52 are arranged in a manner of being spaced from each other at a fixed interval and are connected, in a manner of being parallel to each other, to a surface of the first base plate 51, so that every two adjacent ones of the first fins 52 define therebetween a first heat dissipation trough 53. The first base plate 51 is positioned on and attached to a bottom surface of the electronic speed control 40 such that the first fins 52 are located in the first heat dissipation zone 112 and are set in communication with the bottom surface of the sports carrier 10. Each of the first heat dissipation troughs 53 extends in a direction that is consistent to a moving direction of the sports carrier 10.

Referring to FIGS. 1-5, the second heat dissipation device 60 comprises a second base plate 61 and a plurality of second fins 62. The second fins 62 are arranged in a manner of being spaced from each other at a fixed interval and are connected, in a manner of being parallel to each other, to a surface of the second base plate 61, so that every two adjacent ones of the second fins 62 define therebetween a second heat dissipation trough 63. The second base plate 61 is positioned on and attached to a bottom surface of the battery unit 30 such that the second fins 62 are located in the second heat dissipation zone 113 and are set in communication with the bottom surface of the sports carrier 10. Each of second heat dissipation trough 63 extends in a direction that is consistent to the moving direction of sports carrier 10.

The above provides a description to the constituent components, as well as assembly thereof, of the electrically operated water device 100 according to the first preferred embodiment of the present invention, and features of operation of the present invention will be provided below:

Firstly, when the present invention is put into operation on water surface to move in a direction, heat generated by the electronic speed control 40 is transmitted to the first fins 52 of the first heat dissipation device 50, while heat generated by the battery unit 40 is transmitted to the second fins 62 of the second heat dissipation device 60. Since the first heat dissipation trough 53 and the second heat dissipation trough 63 are arranged to extend in a direction consistent with or the same as a moving direction of the sports carrier 10, water flow is allowed to pass through the first heat dissipation troughs 53 and the second heat dissipation troughs 63 and the water flow, upon contacting the first fins 52 and the second fins 62, brings away the heat so as to provide effects of dissipating heat and lowering temperature.

Thus, the present invention provides effect of dissipating heat from the electronic speed control 40 and the battery unit 30 to protect the electronic speed control 40 and the battery unit 30 from damage and extend service lives thereof. Further, since heat dissipation is carried out directly by external fluid (such as liquid or gas), there is no additional consumption of electrical power.

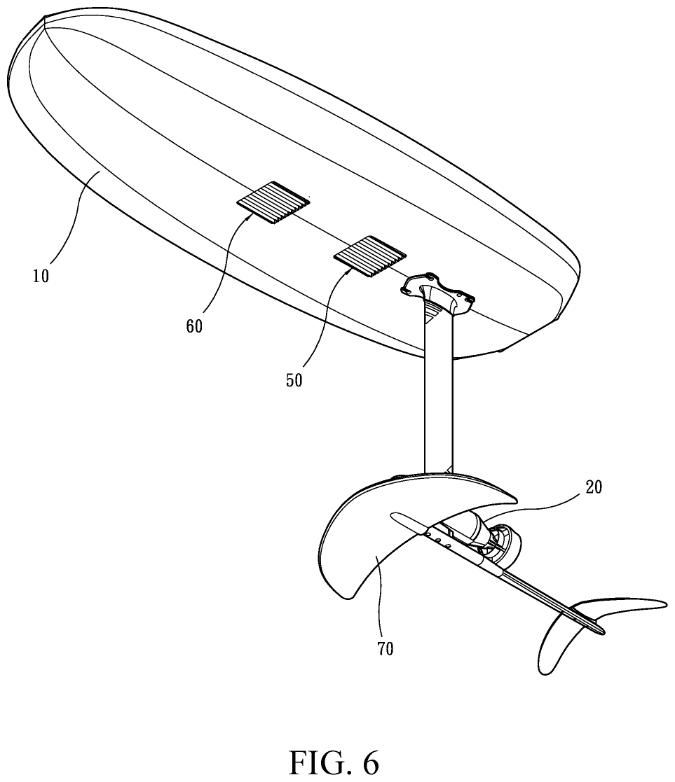

Referring to FIGS. 6-8, an electrically operated water device 200 according to a second preferred embodiment of the present invention is shown, which, similar to the first embodiment, comprises a sports carrier 10, a propeller 20, a battery unit 30, an electronic speed control 40, a first heat dissipation device 50, and a second heat dissipation device 60; however, a major difference of the instant embodiment from the first embodiment is as follows:

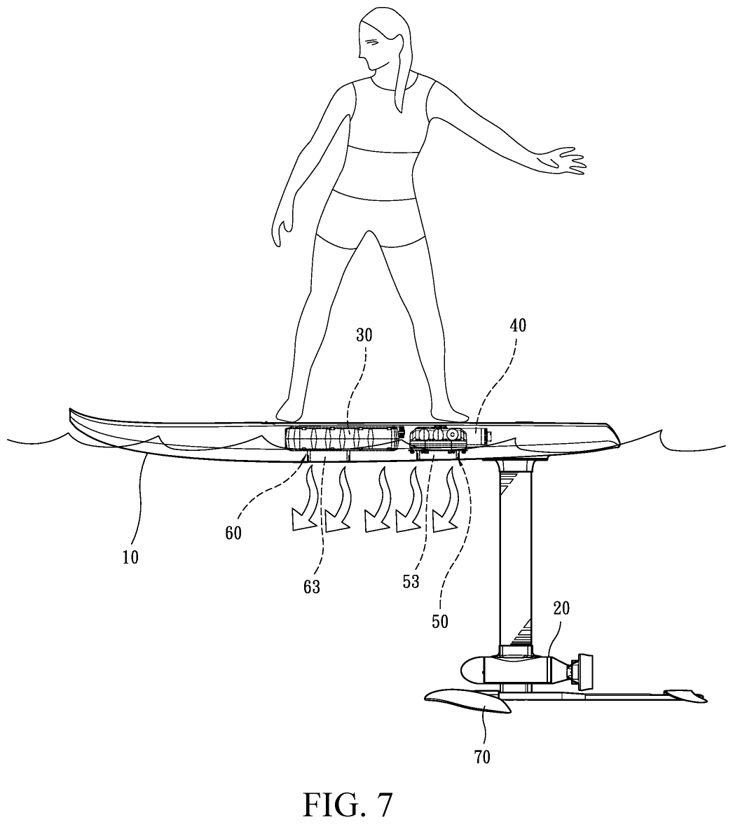

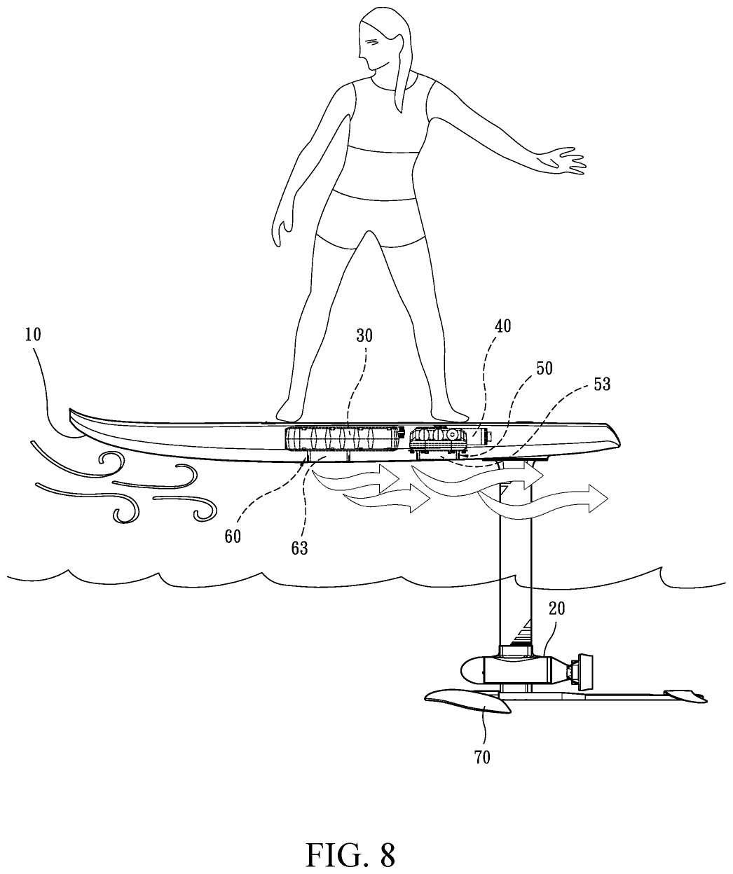

The instant embodiment further comprises a winged keel 70. The winged keel 70 is mounted to the propeller 20 so that when the sports carrier 10 is moving, the bottom of the carrier may be in contact with and supported on water surface (as shown in FIG. 7) or floating above the water surface (as shown in FIG. 8). When the sports carrier 10 is in contact with the water surface, water flow is allowed to pass through the first heat dissipation troughs 53 of the first heat dissipation device 50 and the second heat dissipation troughs 63 of the second heat dissipation device 60 and heat is dissipated by means of the water flow (as shown in FIG. 7). When the sports carrier 10 is floating above the water surface, airflow is allowed to pass through the first heat dissipation troughs 53 of the first heat dissipation device 50 and the second heat dissipation troughs 63 of the second heat dissipation device 60 and heat is dissipated by means of the air flow (as shown in FIG. 8).

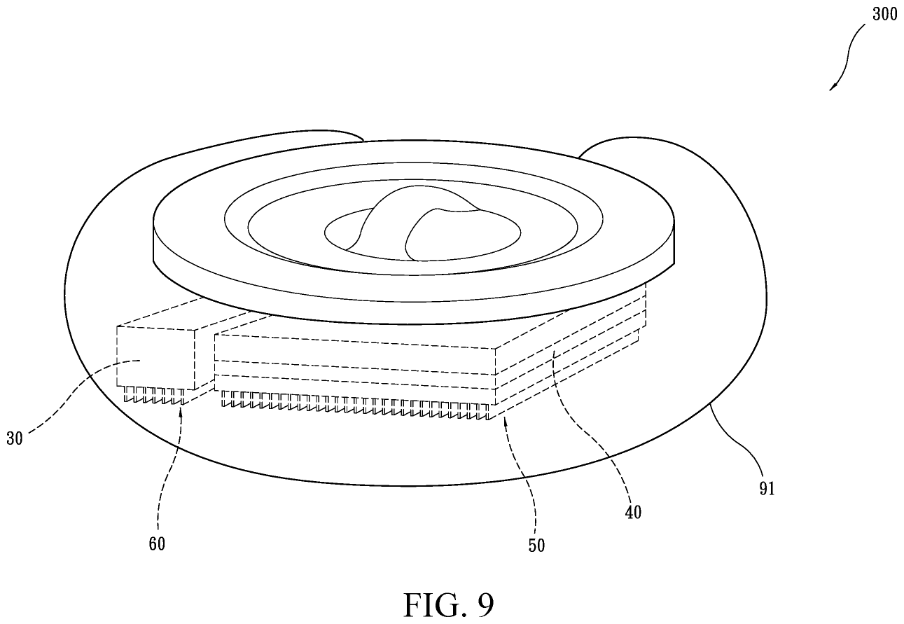

Referring to FIG. 9, an electrically operated water device 300 according to a third preferred embodiment of the present invention is shown, which, similar to the first embodiment, comprises a sports carrier 91, a propeller (not visible in the drawing), a battery unit 30, an electronic speed control 40, a first heat dissipation device 50, and a second heat dissipation device 60; however, a major difference of the instant embodiment from the first embodiment is as follows:

In the instant embodiment, the sports carrier 91 is ring buoy.

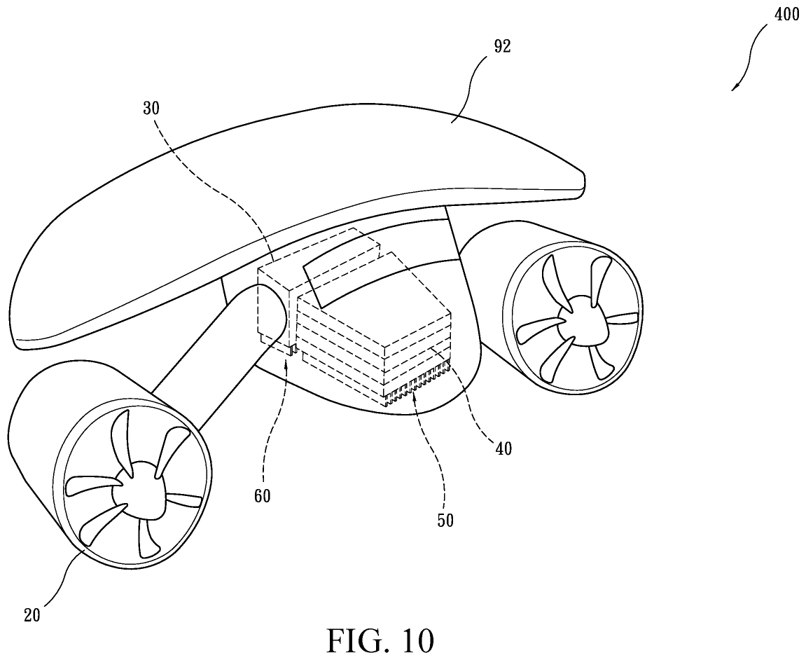

Referring to FIG. 10, an electrically operated water device 400 according to a fourth preferred embodiment of the present invention is shown, which, similar to the first embodiment, comprises a sports carrier 92, at least one propeller 20, a battery unit 30, an electronic speed control 40, a first heat dissipation device, 50 and a second heat dissipation device 60; however, a major difference of the instant embodiment from the first embodiment is as follows:

In the instant embodiment, the sports carrier 92 is a diving assisting device.

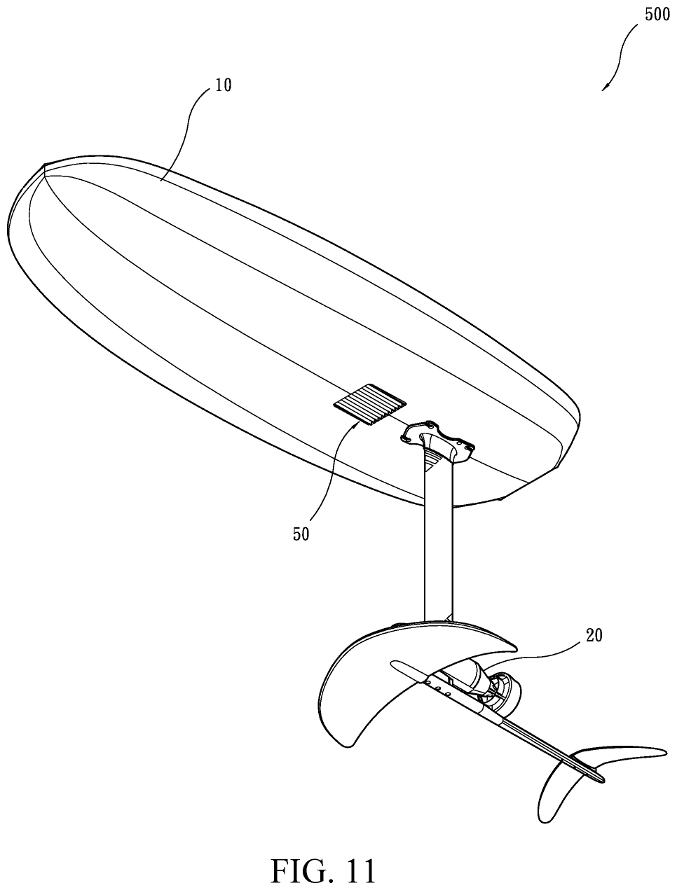

Referring to FIG. 11, an electrically operated water device 500 according to a fifth preferred embodiment of the present invention is shown, which, similar to the first embodiment, comprises a sports carrier 10, a propeller 20, a battery unit (not visible in the drawing), an electronic speed control (not visible in the drawing), and a first heat dissipation device 50; however, a major difference of the instant embodiment from the first embodiment is as follows:

In the instant embodiment, since the amount of heat generated by the battery unit is relatively less, there is no need to provide and arrange a heat dissipation device on the battery unit.

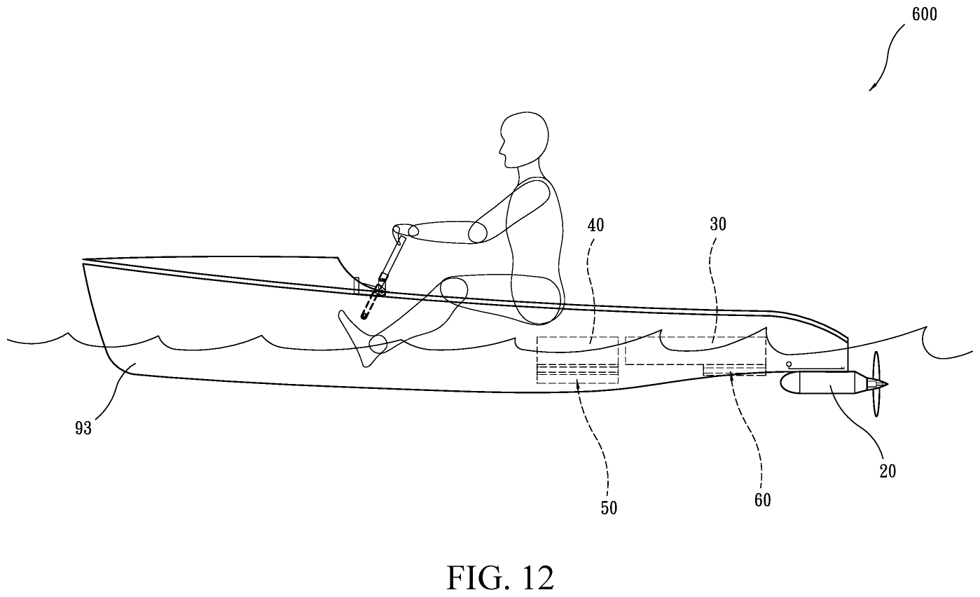

Referring to FIG. 12, an electrically operated water device 600 according to a sixth preferred embodiment of the present invention is shown, which, similar to the first embodiment, comprises a sports carrier 93, a propeller 20, a battery unit 30, an electronic speed control 40, a first heat dissipation device 50, and a second heat dissipation device 60; however, a major difference of the instant embodiment from the first embodiment is as follows:

In the instant embodiment, the sports carrier 93 is a boat, which is moving in a condition of being in contact with water surface.

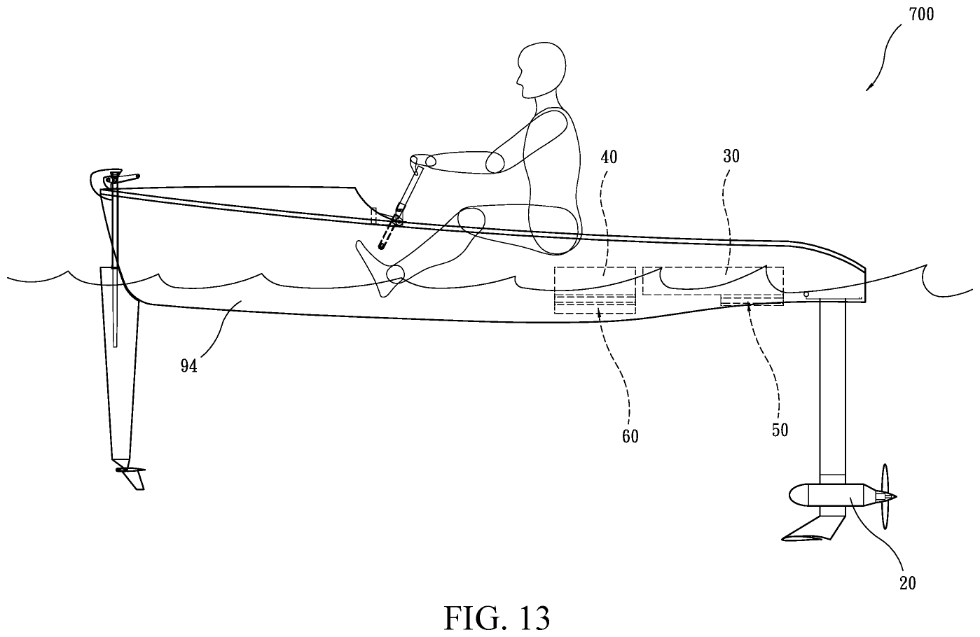

Referring to FIG. 13, an electrically operated water device 700 according to a seventh preferred embodiment of the present invention is shown, which, similar to the first embodiment, comprises a sports carrier 94, a propeller 20, a battery unit 30, an electronic speed control 40, a first heat dissipation device 50, and a second heat dissipation device 60; however, a major difference of the instant embodiment from the first embodiment is as follows:

In the instant embodiment, the sports carrier 94 is a hydrofoil, which is available for moving in a condition of floating above water surface.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An electrically operated water device, comprising:
a sports carrier;
a propeller, which is connected to the sports carrier to generate mechanical power for driving the sports carrier to move in a direction;
a battery unit, which is arranged on the sports carrier for storing and releasing electrical power;
an electronic speed control, which is arranged on the sports carrier and is electrically connected to the battery unit and the propeller to supply electrical power from the battery unit to the propeller and to control an amount of the mechanical power generated by the propeller; and
a first heat dissipation device, which is coupled to the electronic speed control and comprises a plurality of first fins, wherein the first fins are arranged in a manner of being parallel to and spaced from each other at a fixed interval so that every two adjacent ones of the first fins define therebetween a first heat dissipation trough, the first heat dissipation troughs being in communication with a bottom of the sports carrier, each of the first heat dissipation troughs extending in a direction that corresponds to the moving direction of the sports carrier.

2. The electrically operated water device according to claim 1, wherein the sports carrier is a surfboard.

3. The electrically operated water device according to claim 1, wherein the sports carrier comprises a main body and a cover plate, the main body having a top surface, which is recessed downward to form an accommodation zone, the main body having a bottom surface, which is upward recessed to form a first heat dissipation zone, the first heat dissipation zone connecting outside to the accommodation zone, the cover plate being set on and covering the top surface of the main body to close the accommodation zone, the battery unit and the electronic speed control being arranged in the accommodation zone, the first heat dissipation device being arranged in the first heat dissipation zone.

4. The electrically operated water device according to claim 3, further comprising a second heat dissipation device, wherein the bottom surface of the main body is recessed upward to form a second heat dissipation zone, the second heat dissipation zone connecting the outside to the accommodation zone, the first heat dissipation zone and the second heat dissipation zone being spaced from each other by a distance, the second heat dissipation device being coupled to the battery unit and located in the second heat dissipation zone.

5. The electrically operated water device according to claim 4, wherein the second heat dissipation device comprises a plurality of second fins, and the second fins are arranged in a manner of being parallel to each other so that every two adjacent ones of the second fins define therebetween a second heat dissipation trough, the second heat dissipation troughs being in communication with the bottom of the sports carrier, each of the second heat dissipation troughs extending in a direction that corresponds to the moving direction of the sports carrier.

6. The electrically operated water device according to claim 5, wherein the second heat dissipation device further comprises a second base plate, the second fins being arranged parallel to each other and connected to a surface of the second base plate, the second base plate being positioned on and attached to a bottom of the battery unit.

7. The electrically operated water device according to claim 5, wherein the second fins are arranged in a manner of being parallel to and spaced from each other at a fixed interval.

8. The electrically operated water device according to claim 6, wherein the second fins are arranged in a manner of being parallel to and spaced from each other at a fixed interval.

9. The electrically operated water device according to claim 1, wherein the first heat dissipation device further comprises a first base plate, the first fins being arranged parallel to each other and connected to a surface of the first base plate, the first base plate being positioned on and attached to a bottom of the electronic speed control.

10. The electrically operated water device according to claim 9, wherein the first fins are arranged in a manner of being parallel to and spaced from each other at a fixed interval.

11. The electrically operated water device according to claim 1, further comprising a second heat dissipation device, which is coupled to the battery unit and comprises a plurality of second fins, the second fins being arranged parallel to each other so that every two adjacent ones of the second fins define therebetween a second heat dissipation trough, the second heat dissipation troughs being in communication with the bottom of the sports carrier, each of the second heat dissipation troughs extending in a direction that corresponds to the moving direction of the sports carrier.

12. The electrically operated water device according to claim 11, wherein the second heat dissipation device further comprises a second base plate, the second fins being arranged parallel to each other and connected to a surface of the second base plate, the second base plate being positioned on and attached to a bottom of the battery unit.

13. The electrically operated water device according to claim 11, wherein the second fins wherein the second fins are arranged in a manner of being parallel to and spaced from each other at a fixed interval.

14. The electrically operated water device according to claim 12, wherein the second fins wherein the second fins are arranged in a manner of being parallel to and spaced from each other at a fixed interval.

15. The electrically operated water device according to claim 1, further comprising a winged keel, the winged keel being mounted to the propeller.

16. The electrically operated water device according to claim 1, wherein the sports carrier is a ring buoy.

17. The electrically operated water device according to claim 1, wherein the sports carrier is a diving assisting device.

18. The electrically operated water device according to claim 1, wherein the sports carrier is a boat.

19. The electrically operated water device according to claim 1, wherein the sports carrier is a hydrofoil.
